(19) United States
(12) Patent Application Publication
(10) Pub. No.: US 2020/0189949 A1
(43) Pub. Date: Jun. 18, 2020

(54) Glass surface chute manufacturing equipment

(71) Applicant: Yuxiang Fang, Guangzhou City (CN)

(72) Inventor: Yuxiang Fang, Guangzhou City (CN)

(21) Appl. No.: 16/798,430

(22) Filed: Feb. 24, 2020

(30) Foreign Application Priority Data
Nov. 14, 2019 (CN) 2019111154951

(51) Int. Cl. C03B 11/16; C03B 17/06; C03B 11/08; C03C 15/00

(52) U.S. Cl. CPC C03B 11/16; C03B 17/064; C03C 21/002; C03C 15/00; C03B 11/08

(57) ABSTRACT

A glass surface chute manufacturing equipment includes a fuselage, the fuselage includes a circular cavity, including the fuselage, the fuselage includes a fabrication cavity, and the fabrication cavity contains a fabrication mechanism for making chute for glass. A fixed block is fixed on the top wall of the production cavity, and a production block is fixedly connected to the bottom end wall of the production block. A motor is fixed in the production block, and a first transmission cavity is fixed on the lower side of the motor. The device of the present invention The externally connected corrosion solution is connected to the connecting pipe in the device.

### CROSS-REFERENCES TO RELATED APPLICATIONS

The present application claims priority from Chinese application No. 2019111154951 filed on Nov. 14, 2019 which is hereby incorporated by reference in its entirety.

### TECHNICAL FIELD

The present invention relates to the field of glass surface processing, in particular to a glass surface chute manufacturing equipment.

### BACKGROUND OF THE INVENTION

As we all know, the use of glass products is becoming more and more widespread. Nowadays, there are many glass telescopic doors in the market. The most important thing is the specifications of the glass sliding door. Most of the following are artificially manufactured. The quality of such glass chutes cannot be guaranteed, and the efficiency of labor is slow. Therefore, a glass surface chute manufacturing equipment needs to be designed to solve the above problems.

### BRIEF SUMMARY OF THE INVENTION

The technical problem to be solved by the present invention is to provide a glass surface chute manufacturing equipment, which can efficiently produce a functional chute on the glass surface through an etching solution, and the equipment is sensitive and versatile.

The present invention is achieved by the following technical solutions.

A glass surface chute manufacturing equipment includes a fuselage, and the fuselage includes a circular cavity;

The fuselage includes a fuselage, and the fuselage includes a manufacturing cavity. The manufacturing cavity contains a manufacturing mechanism for manufacturing a chute for glass. A fixed block is fixed on the top wall of the manufacturing cavity, and the bottom end wall of the fixed block is fixedly connected and manufactured. A block, a motor is fixed in the production block, a first transmission cavity is fixedly arranged on the lower side of the motor, and a first rotating shaft is rotatably provided in the first driving cavity, and the first rotating shaft is connected to the bottom end surface of the motor Rotating connection, a first gear is fixed on the first rotating shaft, a second rotating shaft is rotated on the front side of the first transmission cavity, and a second gear is fixed on the second rotating shaft. A third rotation shaft is provided for side rotation, and a third gear is fixed on the third rotation shaft. A chain is provided between the first gear, the second gear, and the third gear, and the chain is connected with a first gear. A connecting rod, a first blocking block is fixed at the bottom end of the first connecting rod, an etching liquid pipeline is fixed outside the fixing block, and a corrosive liquid supply pipeline is connected to the top of the etching liquid pipeline and the outside, The outer side of the bottom of the corrosive liquid pipeline is communicated with A ring-shaped chute, a first ring-shaped slider is slidably arranged in the first ring-shaped chute, the first ring-shaped slider can block the bottom end of the corrosion solution pipeline, and a first ring-shaped slider is provided in the first ring-shaped slider. A connecting pipe, the first connecting pipe is in communication with the corrosive liquid pipe;

Supporting blocks are fixed on the left and right end walls of the production cavity. The support block has an open slot therein, the opening slot contains a fixing mechanism for fixing glass, and the support block is provided with a first sliding slot and the first A first slider is slidably arranged in the chute, and a first spring is connected between the top surface of the first slider and the top surface of the first chute. Further, the production mechanism includes the production chamber, and an outer side of the etching solution pipe is fixedly provided with a suction pipe in a top wall of the production chamber, and a top end of the suction pipe is fixed with a discharge pipe communicating with the outside, A second annular chute is fixed outside the bottom end of the suction pipe, and a second annular slide is slidably arranged in the second annular chute, and the second annular slide can block the suction pipe.

Further, a second connecting pipe is provided in the second annular slider, a first transition block is provided on the lower side of the first link, and a first mating cavity is provided in the first transition block. A blocking block cooperates with the first mating cavity to fix the first transition block. A third connection pipe is provided in the first transition block, and an outer end of the third connection pipe is connected to the first connection block. A first soft rubber tube is connected between the pipelines, and an overflow block is fixed at the bottom end wall of the first transition block, and a storage tank is provided in the overflow block in communication with the third connection pipe, and the chain is located at the A second link is fixed on the rear side of the first link, and a second blocking block is fixed on the bottom end of the second link.

Further, a second transition block is fixedly provided on the lower side of the second link, and a second mating cavity is provided in the second transition block. The second mating cavity cooperates with the second blocking block to make the A second transition block is fixed, and a fourth connection pipe is fixedly arranged in the second fixing block. A second soft rubber pipe is connected between the fourth connection pipe and the second connection pipe, and the second transition block A suction port is connected to the bottom end to communicate with the fourth connection pipe.

Further, the fixing mechanism includes the first chute, a limiting hole is provided on the inner end wall of the first slider, a second chute is provided on the lower side of the first chute, and the second chute slides inside A second slider is provided. The first slider can pass through the second slider and the second slider is provided with a projection to cooperate with the limiting hole in the first slider. A pressing block is fixed on the bottom end surface of the first slider, a third sliding slot is fixed on the bottom end wall of the opening slot, and a third sliding block is slidably arranged in the third sliding slot. A second spring is connected between the bottom end surface and the bottom end surface of the third chute, and a hydraulic pipe is provided between the third chute and the second chute. A glass plate is placed in the open slot.

Beneficial effects of the present invention: The device of the present invention is connected to a connecting pipe in the device through an externally connected corrosive solution, and the connecting pipe forms a chute on the glass plate through an overflow block, and the device automatically collects waste material for transportation when the chute is made. Into the outside pipeline, the glass plate's fixing mechanism fixes the glass plate for easy production. The equipment has perfect functions and tight transmission. The production process of the chute on the glass surface is relatively high. The equipment has a high degree of integration and high energy utilization. Rate, while simple operation is safe and fast.

### BRIEF DESCRIPTION OF THE DRAWINGS

In order to more clearly explain the embodiments of the invention or the technical solutions in the prior art, the drawings used in the description of the embodiments or the prior art will be briefly introduced below. Obviously, the drawings in the following description are merely For some embodiments of the invention, for those of ordinary skill in the art, other drawings can be obtained based on these drawings without paying creative labor.

FIG. 1 is a schematic diagram of a mechanical structure according to an embodiment of the present invention;

FIG. 2 is a schematic structural diagram of A-A in FIG. 1;

FIG. 3 is a schematic structural diagram of B-B in FIG. 1;

FIG. 4 is a schematic structural diagram of C-C in FIG. 1.

### DETAILED DESCRIPTION OF THE INVENTION

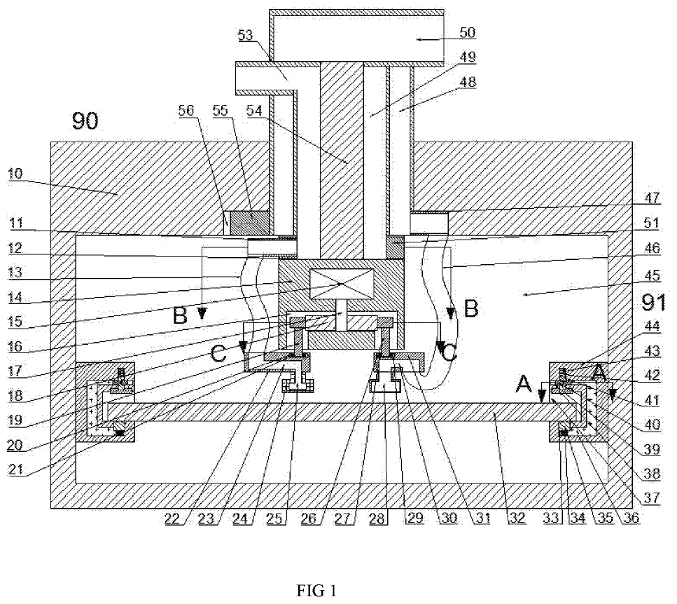

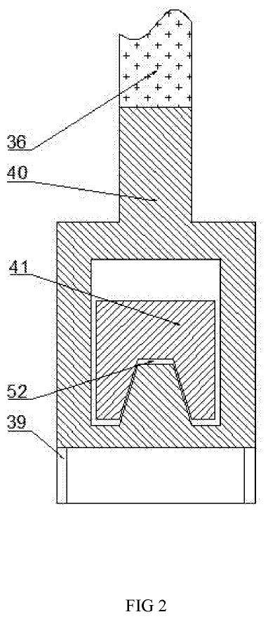

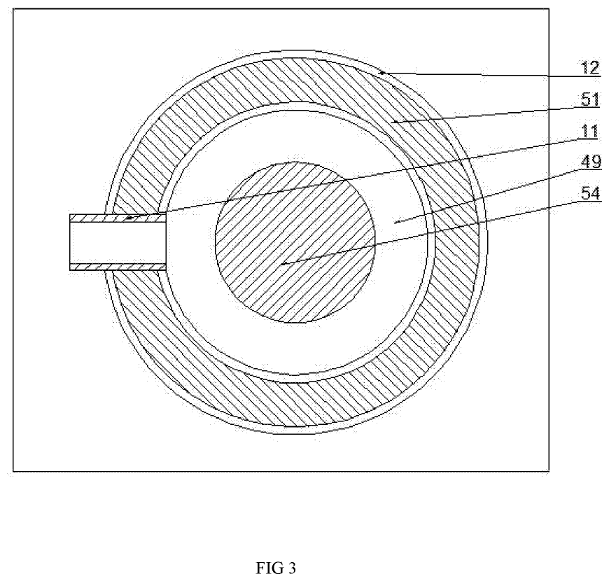

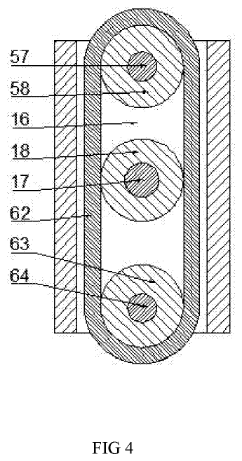

The present invention is described in detail below with reference to FIGS. 1-4. For convenience of description, the orientation described below is defined as follows: the up-down, left-right, front-back direction described below is consistent with the up-down, left-right, front-back direction of the projection relationship of FIG. 1 itself.

A glass surface chute manufacturing equipment described with reference to FIGS. 1-4 includes a fuselage 10, and the fuselage 10 includes a manufacturing cavity 45. The manufacturing cavity 45 contains a manufacturing mechanism 90 for manufacturing a chute for glass. A fixed block 54 is fixed on the top wall of the production cavity 45, and a production block 14 is fixedly connected to the bottom wall of the fixed block 54. A motor 15 is fixed in the production block 14, and a lower side of the motor 15 is fixedly provided. A first transmission cavity 16 is provided with a first rotating shaft 17 rotating therein, the first rotating shaft 17 is rotatably connected to the bottom end surface of the motor 15, and a first rotating shaft 17 is fixedly provided with a first rotating shaft 17. Gear 18, a second shaft 64 is rotatably provided on the front side of the first transmission cavity 11, a second gear 63 is fixed on the second shaft 64, and a third shaft 57 is provided on the rear side of the first shaft 17 A third gear 58 is fixed on the third rotating shaft 57. A chain 62 is provided between the first gear 18, the second gear 63, and the third gear 58, and a chain 62 is connected to the chain 12. A connecting rod 19, a first blocking block 21 is fixed at the bottom end of the first connecting rod 19, and corrosion is fixed on the outside of the fixing block 54 A pipe 49 is provided with a corrosive liquid supply pipe 53 at the top end of the corrosive liquid pipe 49 and the outside. A first annular chute 12 is connected to the outside of the bottom end of the corrosive liquid pipe 49. A first annular slider 51 is provided in the inner slide, and the first annular slider 51 can block the bottom end of the corrosive liquid pipe 49. A first connection pipe 11 is provided in the first annular slider 51. A connecting pipe 11 communicates with the corrosive liquid pipe 49;

Supporting blocks 44 are fixed on the left and right end walls of the production cavity 45. Opening grooves 37 are formed in the support blocks 44. The opening grooves 37 include a fixing mechanism 91 for fixing glass. A sliding slot 42 is provided with a first slider 41 slidably disposed in the first sliding slot 42, and a first spring 43 is connected between a top surface of the first slider 41 and a top surface of the first sliding slot 42.

The production mechanism 90 includes the production chamber 45. A suction pipe 48 is fixedly located on the outer side of the etching liquid pipe 49 in the top wall of the production chamber 45, and the top of the suction pipe 48 is fixedly connected with the outside. The discharge pipe 50 is provided with a second annular chute 56 fixed on the outer side of the bottom end of the suction pipe 48. A second annular slider 55 is slidably arranged in the second annular chute 56. The suction pipe 48 can be blocked, a second connecting pipe 47 is provided in the second annular slider 55, and a first transition block 22 is provided under the first link 19, and the first transition block 22 A first mating cavity 20 is provided therein, the first blocking block 21 cooperates with the first mating cavity 20 to fix the first transition block 22, and a third connection is provided in the first transition block 22 A pipe 23, a first soft rubber pipe 13 is connected between an outer end of the third connecting pipe 23 and the first connecting pipe 11, a bottom end wall of the first transition block 22 is fixed with an overflow block 24, A storage tank 25 is provided in the overflow block 24 in communication with the third connecting pipe 23, and the chain 62 is fixed on the rear side of the first link 19 There is a second link 26, a second blocking block 27 is fixedly arranged on the bottom end of the second link 26, and a second transition block 31 is fixedly arranged on the lower side of the second link 26, the second transition block 31 A second mating cavity 29 is provided therein. The second mating cavity 29 cooperates with the second blocking block 27 to fix the second transition block 31. A fourth connection pipe is fixed in the second fixing block 31 30. A second soft rubber pipe 46 is connected between the fourth connection pipe 30 and the second connection pipe 47, and a bottom end of the second transition block 31 is connected with a communication pipe connected to the fourth connection pipe 30. Suction port 28.

The fixing mechanism 91 includes the first sliding groove 42, a limiting hole 52 is provided on the inner end wall of the first slider 41, and a second sliding groove 39 is provided on the lower side of the first sliding groove 42. A second slider 40 is slidably disposed in the groove 39. The first slider 41 can pass through the second slider 40 and the second slider 40 is provided with a projection and the first slider 41. The limiting hole 52 cooperates with a pressing block 38 fixed at the bottom end surface of the first slider 41, and a third sliding groove 33 is fixed at the bottom end wall of the opening groove 37. A third slider 34 is provided in the inner slide, and a second spring 35 is connected between the bottom end surface of the third slider 34 and the bottom end surface of the third sliding groove 33. The third sliding groove 33 and the first sliding groove 33 are connected to each other. A hydraulic pipe 36 is provided between the two sliding grooves 39, and a glass plate 32 is placed in the opening groove 37.

The sequence of mechanical actions of the entire device:

1. The discharge pipe 50 and the supply pipe 53 are connected to an external device, and the supply pipe 53 passes the corrosive liquid through the first connection pipe 11 into the first soft rubber pipe 13, the first soft rubber pipe The internal corrosive solution 13 enters the third connection pipe 23.

2. Place the glass plate 32 into the opening groove 37, the glass plate 32 squeezes the third slider 34, and the third slider 34 is squeezed through the hydraulic pipe 36 so that The second slider 40 slides inward, and the second slider 40 slides inward no longer restricts the position of the first slider 41. At this time, the first slider 41 is in the position of the first spring 43. Under the action, the first slider 41 slides downward to squeeze the glass plate 32.

3. Turn on the motor 15, the motor 15 drives the first rotating shaft 17 to rotate, the first rotating shaft 17 rotates to drive the first gear 18, and the rotation of the first gear 18 drives the chain 62 to rotate, so The rotation of the chain 62 drives the first link 19 to rotate. The rotation of the first link 19 drives the first transition block 22 to move, and the movement of the first transition block 22 causes the overflow block 24 to contact the glass. Plate 32, the storage tank 25 distributes the corrosive liquid on the overflow block 24, and when the overflow block 24 contacts the glass plate 32, the corrosive liquid creates a chute on the glass plate 32, and when the chute is made After the completion, the chain 62 drives the second link 26 to move, the second link 26 moves to move the second transition block 31, and the movement of the transition block 31 moves the suction port 28, The suction port 28 is moved to suck the corroded glass into the fourth connection pipe 30, the equipment has a high degree of automation, the transmission of each mechanism is tightly matched, and the kinetic energy utilization rate is high.

The above embodiments are only for explaining the technical concept and characteristics of the present invention, and the purpose thereof is to enable those skilled in the art to understand and implement the content of the present invention, but not to limit the protection scope of the present invention. All equivalent changes or modifications made according to the spirit and essence of the present invention shall be covered by the protection scope of the present invention.

1. A glass surface chute manufacturing equipment includes a fuselage, characterized in that the fuselage includes a circular cavity; the fuselage includes a fuselage, and the fuselage includes a manufacturing cavity. The manufacturing cavity contains a manufacturing mechanism for manufacturing a chute for glass. A fixed block is fixed on the top wall of the manufacturing cavity, and the bottom end wall of the fixed block is fixedly connected and manufactured. A block, a motor is fixed in the production block, a first transmission cavity is fixedly arranged on the lower side of the motor, and a first rotating shaft is rotatably provided in the first driving cavity, and the first rotating shaft is connected to the bottom end surface of the motor Rotating connection, a first gear is fixed on the first rotating shaft, a second rotating shaft is rotated on the front side of the first transmission cavity, and a second gear is fixed on the second rotating shaft. A third rotation shaft is provided for side rotation, and a third gear is fixed on the third rotation shaft. A chain is provided between the first gear, the second gear, and the third gear, and the chain is connected with a first gear. A connecting rod, a first blocking block is fixed at the bottom end of the first connecting rod, an etching liquid pipeline is fixed outside the fixing block, and a corrosive liquid supply pipeline is connected to the top of the etching liquid pipeline and the outside, The outer side of the bottom of the corrosive liquid pipeline is communicated with A ring-shaped chute, a first ring-shaped slider is slidably arranged in the first ring-shaped chute, the first ring-shaped slider can block the bottom end of the corrosion solution pipeline, and a first ring-shaped slider is provided in the first ring-shaped slider. A connecting pipe, the first connecting pipe is in communication with the corrosive liquid pipe; supporting blocks are fixed on the left and right end walls of the production cavity. The support block has an open slot therein, the opening slot contains a fixing mechanism for fixing glass, and the support block is provided with a first sliding slot and the first A first slider is slidably arranged in the chute, and a first spring is connected between the top surface of the first slider and the top surface of the first chute.

2. The equipment for making a glass surface chute according to claim 1, wherein the production mechanism comprises the production chamber, and an outer side of the corrosion solution pipe is fixedly provided with a suction pipe in a top wall of the production chamber. The top end of the suction pipe is fixedly provided with a discharge pipe communicating with the outside world. A second annular chute is fixedly fixed on the outside of the bottom end of the suction pipe. The second annular slider may block the suction pipe.

3. The equipment for making a glass surface chute according to claim 2, characterized in that: the second annular slider is provided with a second connection pipe, and a first transition block is provided under the first link, A first mating cavity is provided in the first transition block, the first blocking block cooperates with the first mating cavity to fix the first transition block, and a third is provided in the first transition block. A connecting pipe, a first soft rubber pipe is connected between the outer end of the third connecting pipe and the first connecting pipe, and a bottom end wall of the first transition block is fixed with an overflow block, and the overflow block is A storage tank is connected to the third connecting pipeline, a second link is fixedly arranged on the rear side of the first link, and a second blocking block is fixed to the bottom end of the second link.

4. The device for making a glass surface chute according to claim 3, characterized in that: a second transition block is fixedly provided on the lower side of the second link, and a second mating cavity is provided in the second transition block, The second mating cavity cooperates with the second blocking block to fix the second transition block. A fourth connection pipe is fixed in the second fixing block, and the fourth connection pipe is connected to the second connection block. A second soft rubber tube is connected between the pipelines, and a suction port connected to the fourth connection pipeline is connected to the bottom end of the second transition block.

5. The device for making a glass surface chute according to claim 1, wherein the fixing mechanism comprises the first chute, a limiting hole is provided on an inner end wall of the first slider, and the first chute A second chute is provided on the lower side, and a second slider is slidably arranged in the second chute. The first slider can pass through the second slider and the second slider is provided with a bump. In cooperation with the limiting hole in the first slider, a pressing block is fixedly arranged on the bottom end surface of the first slider, and a third sliding groove is fixedly arranged on the bottom end wall of the opening groove. A third slider is slidably arranged in the chute, and a second spring is connected between the bottom end surface of the third slider and the bottom end surface of the third chute, and the third chute and the second chute Hydraulic pipes are connected between the glass pipes, and glass plates are placed in the open grooves.
